(19) United States
(12) Patent Application Publication
(10) Pub. No.: US 2024/0078583 A1
(43) Pub. Date: Mar. 7, 2024

(54) CUSTOM ATTRIBUTES FOR SEARCH

(71) Applicant: ADOBE INC., SAN JOSE, CA (US)

(72) Inventors: Ronald Eduardo ORIBIO, Austin, TX (US); Robert William BURKE, JR., Pottsboro, TX (US); Michele SAAD, Austin, TX (US); Irgelkha MEJIA, Round Rock, TX (US)

(21) Appl. No.: 17/903,295

(22) Filed: Sep. 6, 2022

(51) Int. Cl. G06Q 30/06

(52) U.S. Cl. CPC G06Q 30/0627; G06Q 30/0631; G06Q 30/0641

(57) ABSTRACT

A search system generates custom attributes for use as search facets. User input associated with an image of a target item available on a listing platform is received. The image is analyzed to determine an attribute of the target item as a custom attribute. A value for the custom attribute is determined for each of a number of other items available on the listing platform that are of the same item type as the target item. Search results are provided based at least in part on the values of the custom attribute for the other items.

### BACKGROUND

Search engines facilitate identifying and returning relevant items from electronic databases, such as, for instance, databases of products. Generally, search engines receive search queries from users and provide search results for items that are responsive to the search queries. For a given search query, a search engine processes the search query, as well as other parameters (e.g., user data, contextual data, and/or other inputs), to identify the most relevant items for the particular search. Search results for identified items can be presented on a user device in several different forms via a search results user interface. In some cases, search engines provide filter options to further facilitate narrowing search results and identifying relevant items.

### SUMMARY

Some aspects of the present technology relate to, among other things, a search system that generates custom attributes for use as search facets to facilitate identifying items with particular attributes. A custom attribute is generated in response to user input. The user input can be in association with a particular target item the user is viewing. Responsive to the user input, an image of the target item is analyzed to determine an attribute of the target item as a custom attribute. In some instances, the entire target item is analyzed, while in other instances, a user-selected portion of the target item is analyzed. The user can specify a name for the custom attribute. Additionally, images of other items of the same item type as the target item are analyzed to determine a value for the custom attribute for each item.

After generating a custom attribute, the custom attribute can be used as a search facet. In some configurations, an indication of a value of the custom attribute is presented with each search result presented to the user. In some configurations, the custom attribute is used to order search results (e.g., based on increasing or decreasing values for the custom attribute) and/or to select/filter search results (e.g., present only search results having a specific value or range of values for the custom attribute).

In some aspects, data for a custom attribute is stored in an item listing datastore. For instance, values for a custom attribute could be added to item listings stored in an item listing datastore and/or a search index of the item listing datastore could be updated to identify item listings with particular custom attribute values. As such, the custom attribute could be used as a search facet for any user. In some instances, a user interface providing filter options is updated to include the custom attribute as a filter option.

In further aspects, custom attributes are recommended to users, site administrators, and/or merchants. Custom attributes are recommended to users for use as search facets, to site administrators who can determine whether to add particular custom attributes as filter options, and/or to merchants who can determine whether to add values for custom attributes as data for their item listings.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIGS. 2A and 2B are diagrams illustrating a listing page with user interface elements for generating a custom attribute in accordance with some implementations of the present disclosure;

FIG. 3 is a diagram illustrating a user interface element for selecting a type of attribute for generating a custom attribute in accordance with some implementations of the present disclosure;

FIG. 4 is a diagram illustrating a user interface for naming a custom attribute in accordance with some implementations of the present disclosure;

FIG. 5 is a diagram illustrating search results with custom attributes of items shown with the search results in accordance with some implementations of the present disclosure;

FIG. 6 is a diagram illustrating search results filtered by a custom attribute in accordance with some implementations of the present disclosure;

FIG. 7 is a flow diagram showing a method for generating and using a custom attribute for search in accordance with some implementations of the present disclosure;

FIG. 8 is a flow diagram showing a method for updating an item listings datastore with data regarding a custom attribute for items in accordance with some implementations of the present disclosure;

FIG. 9 is a flow diagram showing a method for adding a custom attribute as a filter option in a user interface in accordance with some implementations of the present disclosure;

FIG. 10 is a flow diagram showing a method for recommending a custom attribute in accordance with some implementations of the present disclosure; and

FIG. 11 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, an “item listing” refers to a web page providing information for an item. An item listing, can include, among other things, a title identifying the item, a textual description of the item, an image of the item, a video of the item, and one or more reviews submitted by users regarding the item. An item listing can include both unstructured data (e.g., a general text description of the item) and structured data (e.g., an indication of a particular value for a particular attribute of the item). An item listing can be provided, for instance, by a listing platform that provides items available for purchase, rental, streaming, etc.

An “item” can comprise, for instance, a physical product, digital content, or a service. An item can be associated with a particular “item type” that indicates a category of the item.

As used herein, a “target item” refers to an item that is analyzed in accordance with aspects of the technology described herein to identify a custom attribute. In particular, an image of a target item is analyzed to identify a custom attribute associated with the target item or a portion of the target item.

A “listing platform” refers to a site for identifying products or services listed for purchase or rent in response to user input from a client device upon navigation to the site. A listing platform provides interfaces for surfacing of item listings as search results, such as interfaces for receiving search queries and/or filter options. In some instances, a listing platform provides interfaces for searching item listings available at one or more third-party listing platforms.

As used herein, a “custom attribute” comprises a feature of items or a portion of items of a particular item type determined from visual analysis of the items. A custom attribute for a given item indicates the attribute (e.g., attribute name) and a value for the attribute. By way of example only and not limitation, a custom attribute for items of a particular item type could comprise a dimension, a color/pattern, a shape, or a material of items or portions of the items.

### Overview

When browsing items online, users can be overwhelmed by the quantity and variety of items available. This can especially be the case for sites with large catalogs of items. While search engines are incredibly useful tools for locating items, shortcomings in existing search technologies often result in the consumption of an unnecessary quantity of computing resources (e.g., I/O costs, network packet generation costs, throughput, memory consumption, etc.). In some cases, sites provide filter options to allow users to narrow down items returned and hone in on what the users are seeking. The filter options are typically configured based on item attributes, which will vary across different item types (e.g., different filter options would be available for chairs than for televisions). The filter options for a particular item type also vary in quantity and specificity across different sites because the filter options are typically manually selected by site administrators and/or are based on what structured data are available for items. As a result, available filter options are typically limited in scope and don't capture all attributes that users are seeking. In situations where data for a specific attribute is not available for items or has not yet been configured as a search filter, users have to investigate each item result to ascertain from the item details if the item meets a specific criterion.

As a result of shortcomings of conventional search systems, users often have to submit multiple search queries before finding desired items. For example, a user may issue a first search query to a search engine that returns a set of search results. The user may browse the search results and select certain search results to access the corresponding items. Selection of items causes retrieval of the items from various content sources. Additionally, in some cases, applications supporting those items are launched in order to render the items. Often, the search results returned by the search engine don't satisfy the user's goal, requiring the user to spend more time on the search process by repeating the process of issuing additional search queries and selecting certain search results until the user finally accesses a desired item or, in some cases, the user gives up because the search engine was not able to return desired search results even after multiple searches.

These repetitive inputs result in increased computing resource consumption, among other things. For instance, repetitive search queries result in packet generation costs that adversely affect computer network communications. Each time a user issues a search query, the contents or payload of the search query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue search queries, it is expensive because processing search queries consumes a lot of computing resources. For example, for some search engines, a query execution plan may need to be calculated each time a search query is issued, which requires a search system to find the least expensive query execution plan to fully execute the search query. This decreases throughput and increases network latency, and can waste valuable time.

Aspects of the technology described herein improve the functioning of the computer itself in light of these shortcomings in existing search technologies by providing a search system that facilitates the generation of user-specified custom attributes and use of the custom attributes as search facets to facilitate locating items with attributes matching user intent. The custom attributes are based on visual aspects that are determined from analysis of images of items. For instance, a custom attribute could be based on a dimension, color/pattern, shape, or material of items determined from images of the items.

In accordance with some aspects of the technology described herein, the search system receives user input to generate a custom attribute. The user input can be associated with an image of a particular item the user is viewing (i.e., a target item). In some cases, the user input is associated with a portion of the target item. For instance, user input can be received in the form of a box crop around a portion of the target item. Responsive to input to generate a custom attribute, the search system analyzes the image of the target item to identify an attribute associated with the target item as a custom attribute. In some instances, the search system extracts the target item or user-selected portion of the target item from the image using an object segmentation model. The search system analyzes the extracted item or item portion using one or more image processing techniques to identify an attribute for use as a custom attribute. The type of image processing technique employed varies based on the type of attribute being extracted. In some aspects, an item type (e.g., category of item) of the target item is determined and used in identifying the attribute.

Once an attribute has been identified as a custom attribute, the custom attribute can be named by the user. Additionally, the system determines values for the custom attribute for other items of the same item type as the target item. For instance, suppose user input is received selecting a seat portion of a chair and a custom attribute is generated for a seat height. Images of other chairs are analyzed to determine a value of the seat height for each chair. This facilitates using the seat height as a search facet. In some aspects, the search system presents custom attribute values for items with search results. For instance, the search system could present a seat height for each chair search result presented to the user. In some instances in which the custom attribute is a dimension, the search system can also include a size reference image with a search result image for an item (e.g., an image of a person standing next to a chair or sitting on a chair). In some aspects, the search system uses a custom attribute to order search results. For instance, the search system could order search results for chairs based on seat height (e.g., ordered based on increasing or decreasing seat height). In some aspects, the search system uses a custom attribute to select/filter search results. For instance, a user could select to view search results for chairs with a seat height of 18 inches, such that search results for chairs with other seat heights are not presented.

LOOM In some aspects, the search system stores custom attribute data in an item listing datastore storing information regarding item listings for items available to be searched by the search system. For instance, item listings could be updated to include values for custom attributes (e.g., as structured data for each item listing). In some instances, the item listing datastore comprises a search index to facilitate searching items, and the search index is updated to store custom attribute data. In some aspects, custom attribute data is added to an item listing datastore each time a custom attribute is generated. In other aspects, custom attribute data is added to an item listing data based on determining a particular custom attribute has been generated by a number of different users. For instance, the search system could cluster custom attributes generated by different users where custom attributes in a given cluster correspond to the same attribute. A custom attribute can then be selected for addition to the item listing datastore when a cluster contains a threshold number of custom attributes.

By storing data for a custom attribute in the item listing datastore, the custom attribute can be used as a search facet by any user of the search system. In some cases, a filter option is provided for a custom attribute. For instance, a site often presents a user interface with a number of filter options based on an item type being searched. The user interface is updated in some instances to include a custom attribute as another filter option for a relevant item type.

In further aspects, the search system recommends custom attributes to users, site administrators, and/or merchants. Custom attribute recommendations to users allow the users to employ the custom attributes as search facets to facilitate searching items. Custom attribute recommendations to site administrators allow the administrators to determine whether to add certain custom attributes as filter options provided in a user interface. Custom attribute recommendations to merchants allows the merchants to determine whether to add specific information to item listings based on the custom attributes. In some aspects, the custom attribute recommendations are based on the number of times different users have generated the custom attribute indicating a popularity of the custom attribute. In instances in which custom attribute recommendations are provided to users, the recommendations can be based on user attributes, for instance, using collaborative filtering or other recommendation techniques.

Aspects of the technology described herein provide a number of improvements over existing search technologies. For instance, computing resource consumption is improved relative to existing technologies. In particular, generation of custom attributes allows the search system to employ the custom attributes as search facets to more efficiently return relevant search results that match user intent. This eliminates (or at least reduces) the repetitive search queries, search result selections, and rendering of items because the custom attributes facilitate identification of search results for items with attributes that correspond to what the user is seeking without the need to continuously input various search queries to access relevant search results. Accordingly, aspects of the technology described herein decrease computing resource consumption, such as packet generation costs. For instance, a search query (e.g., an HTTP request), would only need to traverse a computer network once (or fewer times relative to existing technologies). Specifically, the contents or payload of the search query is supplemented with header information or other metadata within a packet in TCP/IP and other protocol networks once for the initial user query. Such packet for a search query is only sent over the network once or fewer times. Thus, there is no repetitive or fewer generation of metadata and continuous sending of packets over a computer network.

In like manner, aspects of the technology described herein improve storage device or disk I/O and query execution functionality, as they only need to go out to disk a single time (or fewer times relative to existing search technologies). As described above, the inadequacy of search results from existing search technologies results in repetitive search queries, search result selections, and item renderings. This causes multiple traversals to disk. In contrast, aspects described herein reduce storage device I/O because only minimal inputs are received and so the computing system does not have to reach out to the storage device as often to perform a read or write operation. For example, the search engine can respond with search results that satisfy the user intent from a single search query (or few queries relative to existing technology). Accordingly, there is not as much wear on components, such as a read/write head, because disk I/O is substantially reduced.

Various configurations also improve query execution resource savings. Specifically, for example, the search system calculates a query execution plan on fewer search queries relative to existing search technologies. This increases throughput and decreases network latency because aspects of the technology described herein do not have to repetitively calculate query execution plans because fewer search queries need to be executed, unlike existing search technologies.

Downstream benefits are also provided by aspects of the technology described herein. For instance, using conventional search systems in which users are unable to filter by and correctly purchase items with a specific attribute, there is a higher likelihood of item returns. The use of custom attributes as described herein more effectively prevents users from purchasing items that don't have attributes of interest, thereby reducing returns.

### Example System for Generating and Using Custom Attributes for Search

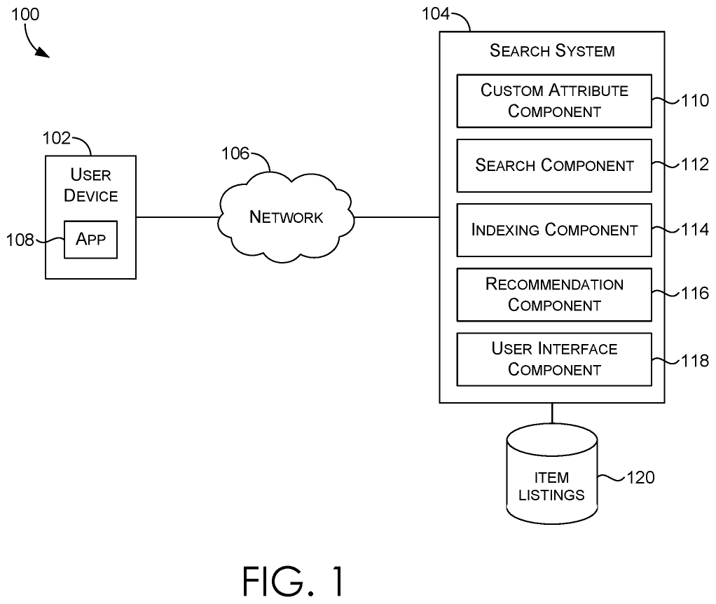

With reference now to the drawings, FIG. 1 is a block diagram illustrating an exemplary system 100 for generating custom attributes and using the custom attributes for search in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

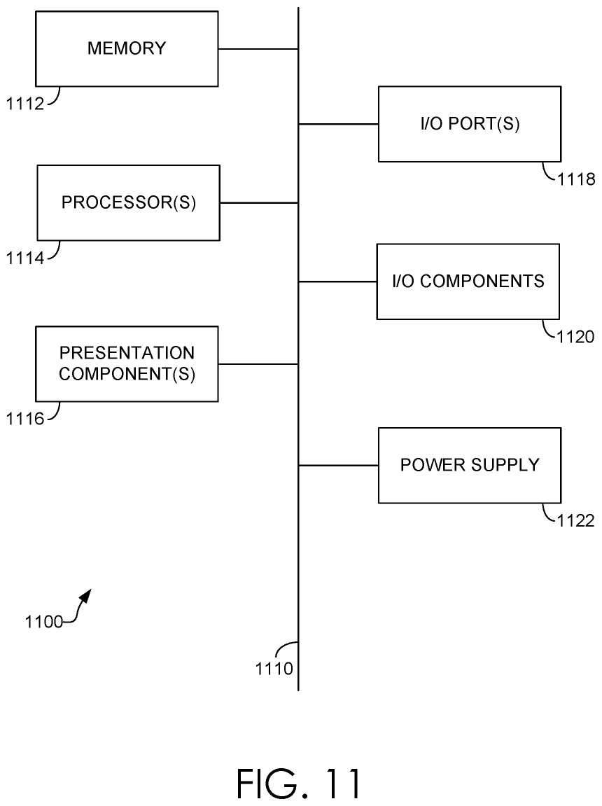

The system 100 is an example of a suitable architecture for implementing certain aspects of the present disclosure. Among other components not shown, the system 100 includes a user device 102 and a search system 104. Each of the user device 102 and search system 104 shown in FIG. 1 can comprise one or more computer devices, such as the computing device 1100 of FIG. 11, discussed below. As shown in FIG. 1, the user device 102 and the search system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and server devices may be employed within the system 100 within the scope of the present technology. Each may comprise a single device or multiple devices cooperating in a distributed environment. For instance, the search system 104 could be provided by multiple server devices collectively providing the functionality of the search system 104 as described herein. Additionally, other components not shown may also be included within the network environment.

The user device 102 can be a client device on the client-side of operating environment 100, while the search system 104 can be on the server-side of operating environment 100. The search system 104 can comprise server-side software designed to work in conjunction with client-side software on the user device 102 so as to implement any combination of the features and functionalities discussed in the present disclosure. For instance, the user device 102 can include an application 108 for interacting with the search system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the search system 104 remain as separate entities. While the operating environment 100 illustrates a configuration in a networked environment with a separate user device and search system, it should be understood that other configurations can be employed in which components are combined. For instance, in some configurations, a user device may also provide search capabilities.

The user device 102 may comprise any type of computing device capable of use by a user. For example, in one aspect, the user device may be the type of computing device 1100 described in relation to FIG. 11 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the search system 104 via the user device 102.

At a high level, the search system 104 facilitates generation of custom attributes for searching items. As shown in FIG. 1, the search system 104 includes a custom attribute component 110, a search component 112, an indexing component 114, a recommendation component 116, and a user interface component 118. The components of the search system 104 may be in addition to other components that provide further additional functions beyond the features described herein. The search system 104 can be implemented using one or more server devices, one or more platforms with corresponding application programming interfaces, cloud infrastructure, and the like. While the search system 104 is shown separate from the user device 102 in the configuration of FIG. 1, it should be understood that in other configurations, some or all of the functions of the search system 104 can be provided on the user device 102.

In one aspect, the functions performed by components of the search system 104 are associated with one or more applications, services, or routines. In particular, such applications, services, or routines may operate on one or more user devices, servers, may be distributed across one or more user devices and servers, or be implemented in the cloud. Moreover, in some aspects, these components of the search system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

In some examples, the search system 104 is part of a listing platform. Examples of listing platforms include e-commerce platforms, in which listed products or services are available for purchase by a user of a client device upon navigation to the platforms. Other examples of listing platforms include rental platforms listing various items for rent (e.g., equipment, tools, real estate, vehicles, contract employees) and media platforms listing digital content items (e.g., content for download). A listing platform can comprise any site for identifying products or services listed for purchase or rent by a user of a client device upon navigation to the site, including items that are available at one or more third-party listing platforms.

The functionality of a listing platform includes provision of interfaces enabling surfacing of item listings for items to users of the listing platform. Item listings for items available for sale/rent via the listing platform are stored by the item listings datastore 120. Each item listing may include a description relating to the item comprising one or more of a price in a currency, reviews, images of the item, shipment options, a rating, a condition of the item, a size of the item, a color of the item, etc. In aspects, the item is associated with one or more categories including meta-categories and leaf categories. For example, the meta-categories are each divisible into subcategories (or branch categories), whereas leaf categories are not divisible. In some aspects, the item listings datastore 120 comprises a search index that stores structured data regarding item listings to facilitate searching the item listings.

The custom attribute component 110 of the search system 104 facilitates the generation of a custom attribute for searching items in the item listings datastore 120. For instance, the custom attribution component 110 facilitates generation of custom attributes associated with certain features of items, such as, for instance, dimension/size, color/pattern, shape, or material of the items. The custom attribute is generated by the custom attribute component 110 in response to user input to create the custom attribute.

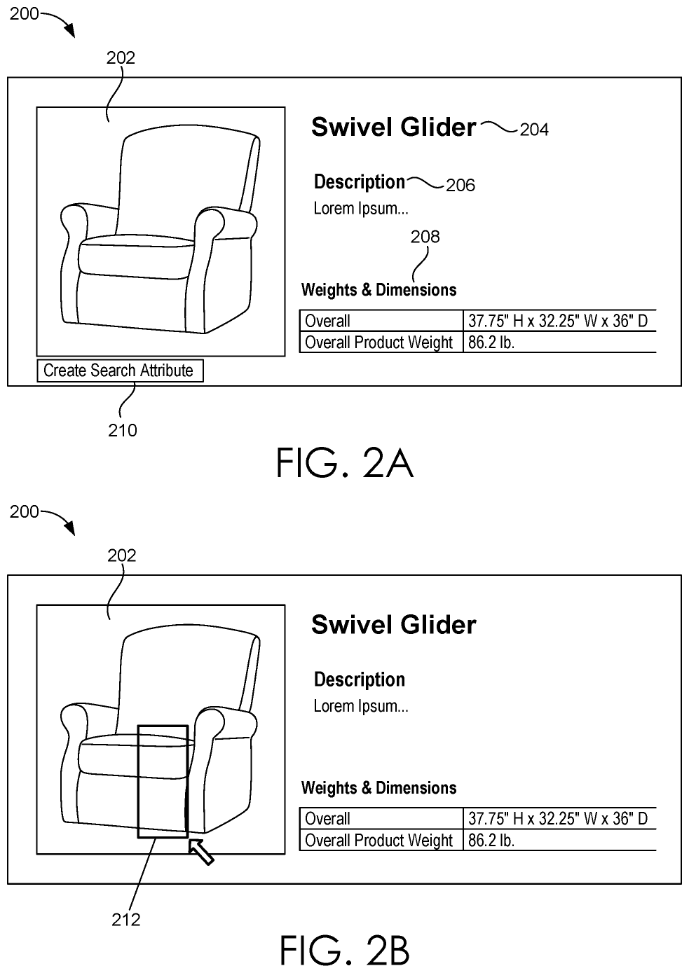

In some aspects, a custom attribute is generated based on analysis of an image of an item being viewed by the user (referred to herein as a target item). For instance, a custom attribute can be generated by analyzing an image of a target item when a user is viewing a listing page for the target item. By way of example, FIG. 2A illustrates a listing page 200 for a chair (i.e., the target item). As shown in FIG. 2A, the listing page 200 includes (among other things not shown), an image 202 of the item, a title 204 of the item, a description 206 for the item, and dimensions 208 for the item (which could be stored as structured text for the item listing). The user interface also includes a button 210 to generate a custom attribute. In response to a user selecting the button 210, the custom attribute component 110 analyzes the image 202 to determine an attribute of the chair for generating a custom attribute that can be used to search for chairs.

In some instances, the customer attribute component 110 identifies an attribute from only a portion of the target item based on user input specifying the portion of the target item. The user input specifying the portion of the target item to analyze could comprise, for instance, a box crop drawn by the user around a specific portion of the target item in the image of the target item. This allows a user to create a custom attribute based on an attribute associated with only a portion of the target item as opposed to the entire target item. For example, if the user desires to search chairs based on seat height, the user could select a seat portion of a chair being viewed. As another example, if a user desires to search purses based on a color of a strap as opposed to the body of the purse, the user could select a portion of the image with the strap. By way of example to illustrate, FIG. 2B shows the listing page 200 in which a user has drawn a box crop 212 over a portion of the chair shown in the image 202. In particular, the user has selected a seat portion of the chair (e.g., to determine a seat height dimension).

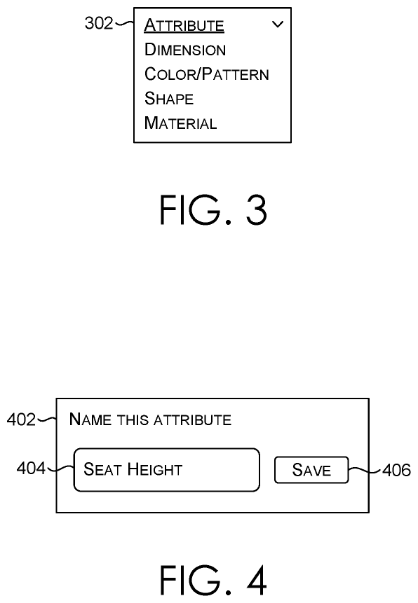

When user input to create a custom attribute is received, the custom attribute component 110 analyzes the image of the target item (i.e., analyzing the entire target item or only a portion of the target item) to identify one or more attributes. In some cases, the custom attribute component 110 determines a single custom attribute from the image of the target item. For instance, a user interface element could be provided that allows a user to specify a type of custom attribute from a selection of pre-defined custom attribute types. In such configurations, the user can specify which type of custom attribute to generate. By way of example, FIG. 3 illustrates a drop down box 302 that allows a user to select a particular type of attribute for generating a custom attribute. For instance, a user could select to generate a custom attribute regarding a specific dimension, and the custom attribute component 110 analyzes the image of the target item to identify the dimension. In other cases, the custom attribute component 110 determines multiple attributes from the image of the target item. For instance, the custom attribute component 110 could identify multiple attributes (e.g., multiple dimensions of the target item, a color of the target item, a shape associated with the target item, and a material of the target item) and present those multiple attributes to the user for the user to select which attribute to use for generating a custom attribute.

To identify an attribute from the image of the target item in some aspects, the custom attribute component 110 extracts the target item and/or the user-selected portion of the target item from the image. The extraction can be performed using, for instance, an object segmentation model that extracts portions of the image corresponding with the target item or the user-selected portion. In some instances in which the user has selected an item portion, the custom attribute component 110 can use image recognition to identify the portion of the target item that has been selected. For example, if a user selects the sleeve of a jacket to search for an attribute of jacket sleeves (as opposed to the main jacket body), the custom attribute component 110 uses image recognition techniques to identify the selected portion as corresponding to a sleeve portion. The analysis can be based in part on an item type determined, for instance, from a category of the target item specified by the listing platform or a category identified from image recognition performed on the image.

The custom attribute component 110 analyzes the extracted portion of the image using one or more image processing techniques to identify an attribute of the target item or the user-selected portion. The type of image processing technique employed depends on the type of attribute being extracted. For instance, in the case of a dimension, rules of proportionality can be used to determine a dimension. In particular, given known dimensions of the target item from the item listing, a dimension for a portion of the target item is determined. As an example to illustrate, a dimension of a chair (e.g., seat height) can be calculated from an image of the chair given a known overall height and/or width of the chair (e.g., an overall height and width of the chair specified by the item listing). For instance, if the overall height of a chair is 40 inches and analysis of the image of the chair indicates that the seat height is 45% of the overall height, the seat height is determined to be 18 inches. As another example, in the case of a color or pattern, image analysis can be performed based on color values of the pixels of the extracted target item or target item portion. As a further example, in the case of a shape, image analysis can be performed to identify a shape of a boundary of the extracted target item or target item portion. As yet another example, in the case of a material, a machine learning model (e.g., a neural network) trained to identify materials of objects from images can be employed to analyze the extracted target item or target item portion to determine a material for the target item or target item portion. In some configurations, the custom attribute component 110 uses an item type of the target item when determining the attributes.

In some configurations, an attribute identified by the custom attribute component 110 can be presented to the user such that the user can review the attribute and confirm whether to use the attribute as a custom attribute for searching items. In other configurations, an attribute identified by the custom attribute component 110 is identified as a custom attribute without user confirmation.

In some aspects, the user names a custom attribute identified by the custom attribute 110. The name can be used, for instance, when using the custom attribute as a search facet, as described below. By way of example, FIG. 4 provides a user interface element 402 for naming a custom attribute. As shown in FIG. 4, a text box 404 is provided allowing the user to enter a desired name for the custom attribute. In this example, the user is generating a custom attribute of seat height for chairs, and has named the custom attribute “seat height”. Once entering the name, the user saves the name for the custom attribute by selecting the save button 406.

Once an attribute has been identified as a custom attribute (with or without user confirmation), the custom attribute is used to facilitate searching items. In particular, the custom attribute component 110 analyzes images of other items of the same item type as the target item to determine an attribute for each of the other items corresponding to the custom attribute. In the case in which the custom attribute is determined from a portion of the target item, the same portion of other items is analyzed. For instance, in an example in which a user desires to search chairs based on seat height such that a seat height attribute is determined as a custom attribute based on a the target item, the attribute component 110 analyses images of other chairs to determine a seat height for each of those other chairs. As another example, if a custom attribute is generated for color of a purse strap, the strap portion of other purses is analyzed to determine the color of each strap.

The search component 112 uses a custom attribute generated by the custom attribute component 110 as a search facet to facilitate search for items. In some cases, custom attributes identified for items are used by the search component 112 to order and/or select/filter items based on values of the custom attribute for items. For instance, using the example in which a seat height custom attribute for chairs is generated, the search component 112 could present chairs as search results in which the chairs are ordered based on seat height (e.g., ordered with increasing or decreasing seat height). Alternatively, again using the seat height example, the search component 112 could use the custom attribute to select/filter chairs such that only chairs with a particular seat height are presented. In some cases, one or more user interface elements are provided to allow the user to specify or select a particular value or range of values for viewing items with the specified/selected value or range of values. For example, in the example of the seat height custom attribute, the search height custom attribute could be added as a filter option with a text box allowing a user to enter a particular seat height value or particular range of seat height values. In some cases, the search component 112 provides items with the same value of the custom attribute as the target item. For example, if the target chair for a seat height custom attribute has a seat height of 18 inches, the search component 112 could present only chairs with a seat height of 18 inches. As another example, a custom attribute could be generated based on a target dress being sleeveless (i.e., a shape custom attribute), and the search component 112 could present only sleeveless dresses.

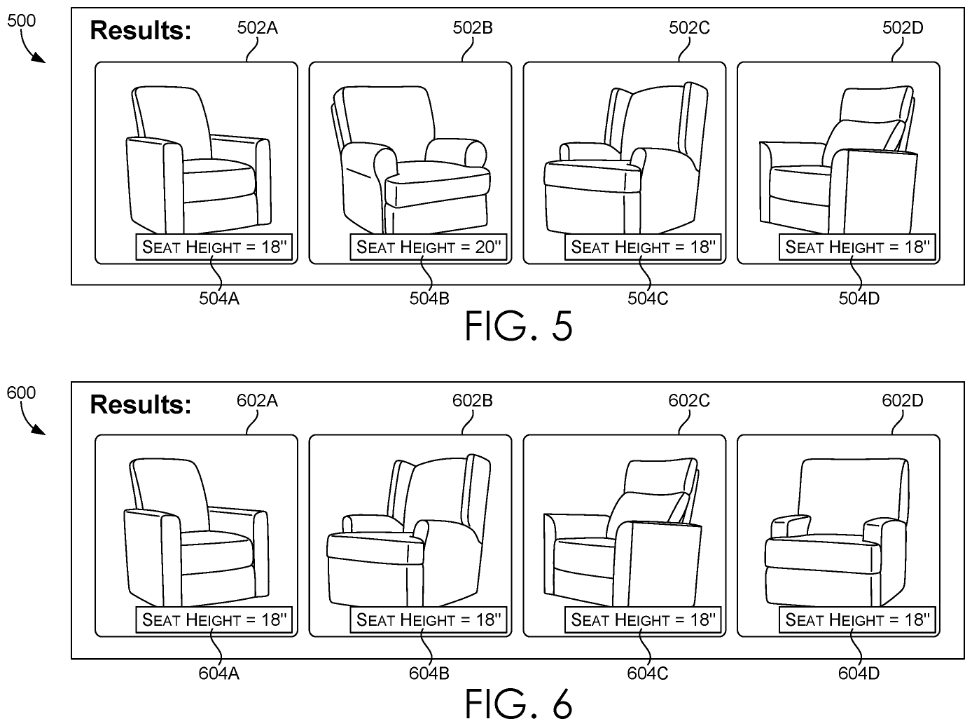

In some aspects, the search component 112 presents values of the custom attribute of items as a part of the search results. For instance, using the seat height custom attribute example, the search component can present a set of search results of chairs with an indication of the seat height for each search result. By way of example to illustrate, FIG. 5 presents a search results interface 500 that includes search results 502A-502D for chairs. As shown in FIG. 5, a seat height attribute 504A-504D is shown with each of the search results 502A-502D indicating the seat height for each of the chairs associated with the search results 502A-502D.

In the example of FIG. 5, the search results have not been ordered or selected/filtered based on the seat height custom attribute. Instead, FIG. 5 presents an example in which an indication of the custom attribute values is shown although the custom attribute has not been used for ordering or selecting/filtering search results. FIG. 6 provides an example in which the custom attribute has been used to select/filter search results. In particular, FIG. 6 presents a search results interface 600 that includes search results 602A-602D for chairs. In the example of FIG. 6, the search results interface 600 only includes chairs with a seat height of 18 inches, as can be seen by the seat height attribute 604A-604D shown with each of the search results 602A-602D.

Referring again to FIG. 1, the indexing component 114 of the search system 104 updates the item listings datastore 120 with information associated with custom attributes extracted for items by the custom attribute component 110. For instance, the indexing component 114 could store values of a custom attribute determined for items as an attribute of each item's corresponding item listing. In some instances, the item listings datastore 120 comprises a search index (e.g., one or more inverted indices) that facilitates search, and the indexing component 114 indexes information regarding a custom attribute in the search index. For instance, an inverted index could be generated for a custom attribute in which item listings of a particular item type are stored in association with values for the custom attribute as a primary key of the inverted index (e.g., identifiers of item listings for chairs stored with corresponding seat height values as the primary key).

In some instances, the indexing component 114 stores custom attributes for items each time a user generates a custom attribute. In other instances, instead of indexing a custom attribute each time a custom attribute is generated, the indexing component 114 analyzes custom attributes from multiple users to determine which custom attributes to index. This could be based on a frequency with which a particular custom attribute is generated by users. For instance, a machine learning model could be trained to identify commonly occurring custom attributes for a given item type. This could include clustering custom attributes based on features of the custom attributes and determining to index a custom attribute based on a cluster including a threshold number of custom attributes.

Once the indexing component 114 has updated the item listings datastore 120 to include information for a custom attribute for items, the search component 112 can leverage the custom attribute information in the item listings datastore 120 when returning search results to any user of the search system 104. As discussed above, the search component 112 can use a custom attribute to order and/or select/filter search result items. In some instances, a user can specify a custom attribute to use for search via a text query. For instance, a user could enter a search query such as: “chairs with 18 inch seat height.” In other instances, a filter search interface of the search system is updated to add a custom attribute as a filter option. For instance, in the example of the seat height custom attribute, the set of filters shown when searching chairs could be updated to include seat height as an option for filtering chairs shown as search results. In further instances, the search results interface could include an option to sort search results based on a custom filter. For instance, chair search results could be ordered based on increasing or decreasing seat height. In some configurations, the search component 112 provides an indication of a custom attribute value with each search result (e.g., as shown in the examples of FIGS. 5 and 6).

In some instances in which a custom attribute is associated with a dimension for items, the search component 112 also includes a size reference image with each search result image to provide a visualization of a relative size of each item. For instance, the size reference image can be an image of a human or humanoid standing next to an item, sitting on an item, or holding an item to demonstrate the relative size of the item.

The recommendation component 116 of the search system 104 selects custom attributes to recommend. Custom attribute recommendations can be made to different entities for different purposes in accordance with various aspects of the technology described herein. In some aspects, custom attribute recommendations are provided to users of the search system 104. This allows users to search items using the recommended custom attributes. For instance, a custom attribute of “seat height” for chairs could be provided as a recommendation to a user viewing search results for chairs. Given the recommendation, the user can choose to sort and/or select/filter the search results based on the recommended custom attribute.

In some aspects, custom attribute recommendations are provided to an administrator of the search system 104. This allows the administrator to determine whether to add certain custom attributes as filter options provided in a user interface of the search system 104. Continuing the example of a seat height custom attribute for chairs, the administrator can view the recommended custom attribute and decide whether to add a “seat height” filter option to a collection of filter options included as part of a user interface provided by the search system 104 when users are searching/browsing/viewing chairs.

In further aspects, custom attribute recommendations are provided to merchants offering items via item listings. This allows the merchants to determine whether to add information to item listings based on the custom attributes. Using the example of the seat height custom attribute for chairs, a recommendation can be provided to a merchant to add a seat height dimension as part of the item listing. The seat height dimension specified by the merchant can be used when users are searching for chairs, and/or the seat height dimension specified by the merchant can be included as additional information presented as part of the description of the chair when users are viewing the item listing for the chair.

In some aspects, the recommendation component 118 selects custom attributes to recommend based on the number of times different users have generated the custom attribute. For instance, a machine learning model could be trained to identify commonly occurring custom attributes for a given item type. This could include clustering custom attributes based on features of the custom attributes and determining to recommend a custom attribute based on a cluster including a threshold number of custom attributes.

In the case of recommending custom attributes to users, the recommendation component 118 can select custom attributes for recommendation based on user attributes. In some configurations, a machine learning model is trained to recommend/surface commonly occurring custom attribute types with certain item types to users likely to be interested in such an attribute. The recommendation component 118 can employ, for instance, a collaborative filtering technique to select custom attributes to recommend to particular users based on user attributes (e.g., demographics, user behavior such as search behavior, purchasing behavior, etc.). User segments can be identified and custom attribute recommendations specifically targeted to particular user segments based on likelihood of relevance of the custom attributes to the user segments.

The user interface component 118 of the search system 104 provides one or more user interfaces for interacting with the search system 104. For instance, the user interface component 118 can provide user interfaces to a user device, such as the user device 102. Among other things, the user interfaces provided by the user interface component 118 can enable a user to interact with the search system 104 to generate a custom attribute. This can include, for instance, selecting a target item, portion of a target item, and/or attribute type for generating a custom attribute, as well as naming the custom attribute. The user interface component 118 also provides one or more user interfaces to a user device, such as the user device 102, that enable use of a custom attribute for search. For instance, in some configurations, a custom attribute is added to a set of filter options provided in a search interface. As another example, in some configurations, a custom attribute is provided as a sort option for sorting search results based on the custom attribute.

### Example Methods for Generating and Using Custom Attributes for Search

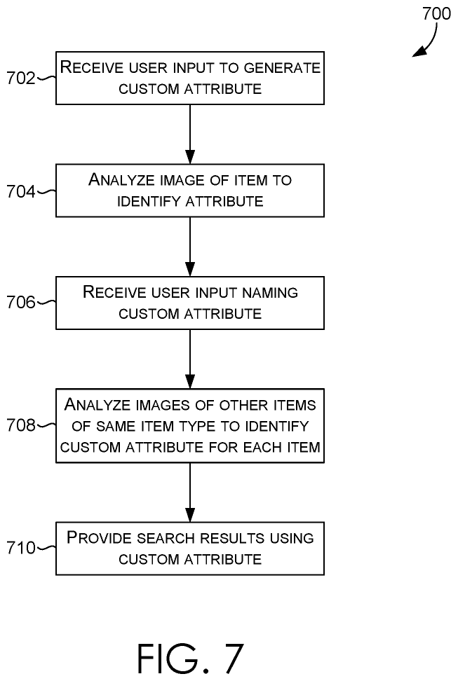

With reference now to FIG. 7, a flow diagram is provided that illustrates a method 700 for generating and using a custom attribute for search. The method 700 may be performed, for instance, by the search system 104 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, user input is received to generate a custom attribute for search. The user input is received in association with an item listing for a target item of a particular item type. In some aspects, a user interface displaying the item listing provides one or more user interface elements enabling the user to provide input to generate a custom attribute. This could include, for instance, user interface elements to initiate generation of a custom attribute, select a target item or portion of a target item, and/or select a particular attribute type.

An image of the target item in the item listing is analyzed to identify an attribute, as shown at block 704. In some configurations, the entire image is analyzed. In other configurations, a portion of the image selected by the user is analyzed. For instance, a user could draw a box crop around a portion of the target item shown in the image. The analysis can include extracting the target item from the image or a portion of the target item from a user-selected portion of the image. The extraction can be performed using, for instance, an object segmentation model that extracts portions of the image corresponding with the target item.

The extracted image portion is analyzed using one or more image processing techniques to identify an attribute of the target item. The type of image processing technique employed depends on the type of attribute being extracted. For instance, in the case of a dimension, rules of proportionality can be used to determine a dimension. In particular, given known dimensions from the item listing, a dimension for a portion of the target item is determined. As another example, in the case of a color or pattern, image analysis can be performed based on color values of the pixels of the extracted target item or target item portion. As a further example, in the case of a shape, image analysis can be performed to identify a shape of a boundary of the extracted target item or target item portion. As yet another example, in the case of a material, a machine learning model (e.g., a neural network) trained to identify materials of objects from images can be employed to analyze the extracted target item or target item portion to determine a material for the target item or target item portion.

Any number of attributes can be determined at block 704. In some instances, only a single attribute is identified. For instance, a user could specify a type of attribute for which a custom attribute is to be created. In other instances, several different types of attributes are determined, and the different attributes are presented to the user for user input to generate a custom attribute with a user-selected attribute.

As shown at block 706, user input is received naming the custom attribute identified at block 704. For instance, in the example in which the user has selected a seat portion of a chair to get a dimension of the seat height, the user can provide input, such as “seat height,” to name the custom attribute.

Images in item listings of other items of the same item type as the target item are analyzed to determine values for the custom attribute for those items, as shown at block 708. In some aspects, the analysis is similar to that performed on the target item at block 704. For each item, an image is obtained from an item listing. The item or an item portion is extracted from the image, and one or more image processing techniques are employed to determine the value of the custom attribute for the item. For example, if a seat height was determined for the target item at block 704, a seat height is determined for other chairs. As another example, if a material of a purse strap was determined for the target item at block 704, the material of straps for other purposes is determined.

Search results are provided using the custom attribute for the items, as shown at block 710. In some aspects, this includes showing a value of the custom attribute with each search result. For instance, a seat height could be identified for each chair search result shown when searching chairs. In some aspects, the custom attribute is used as a search facet to order and/or select/filter search results based on the value of the custom attribute for each item. For instance, seat height could be used to order and/or select/filter search results for chairs.

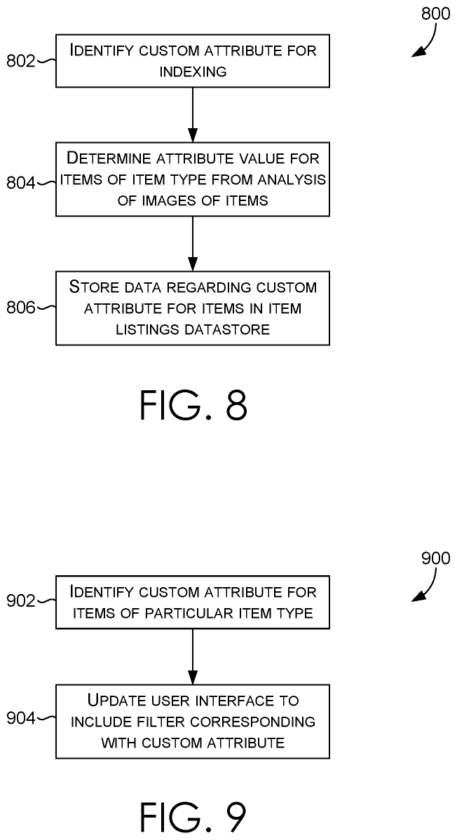

Turning next to FIG. 8, a flow diagram is provided showing a method 800 for updating an item listings datastore with data regarding a custom attribute for items. The method 800 can be performed, for instance, by the search system 104 of FIG. 1. As shown at block 802, a custom attribute is identified for indexing. The custom attribute is associated with a particular item type. In some instances, the custom attribute is identified for indexing when a custom attribute is generated for a single user (e.g., using the method 700 of FIG. 7). In other instances, the custom attribute is identified for indexing based on analysis of a collection of custom attributes from multiple users. This could be based on a frequency with which a particular custom attribute is generated by users. For instance, a machine learning model could be trained to identify commonly occurring custom attributes for a given item type. This could include clustering custom attributes based on features of the custom attributes and determining to index a custom attribute based on a cluster including a threshold number of custom attributes.

As shown at block 804, a value for the custom attribute is determined for items of the item type associated with the custom attribute. For instance, if the custom attribute is a seat height for chairs, a seat height value is determined for each chair in an item listings datastore. The value for the custom attribute for each item can be determined by analyzing an image of the item.

Data regarding the custom attribute is stored in an item listings datastore, as shown at block 806. In some aspects, this comprises storing a value of the custom attribute with data for an item listing. For instance, seat height values for chairs could be stored as part of the item listings for the chairs. In some aspects, a search index is updated with the custom attribute. For instance, an inverted index could map values of the custom attribute to items having corresponding custom attribute values. This facilitates searching (ordering/selecting/filtering) items based on values of the custom attribute for the items.

With reference now to FIG. 9, a flow diagram is provided showing a method 900 for adding a custom attribute as a filter option in a user interface. The method 900 can be performed, for instance, by the search system 104 of FIG. 1. As shown at block 902, a custom attribute is identified for items of a particular item type. In some instances, the custom attribute is identified when a custom attribute is generated for a single user (e.g., using the method 700 of FIG. 7). In other instances, the custom attribute is identified as a filter option based on analysis of a collection of custom attributes from multiple users. This could be based on a frequency with which a particular custom attribute is generated by users. For instance, a machine learning model could be trained to identify commonly occurring custom attributes for a given item type. This could include clustering custom attributes based on features of the custom attributes and selecting a custom attribute based on a cluster including a threshold number of custom attributes.

As shown at block 904, a user interface for searching items of the particular item type is updated to include the custom attribute as a filter option. For instance, a user interface for searching chairs could include a number of filter options for filtering chairs based on different attributes. The user interface is updated to include a custom attribute, such as seat height, as one of the filter options. The user interface could be updated to include specific values or ranges of values of the custom attribute to allow a user to select to view items corresponding to a selected custom attribute value or range of values. The values or ranges of values provided for a filter option are determined based on the distribution of values for the custom attribute determined for items.

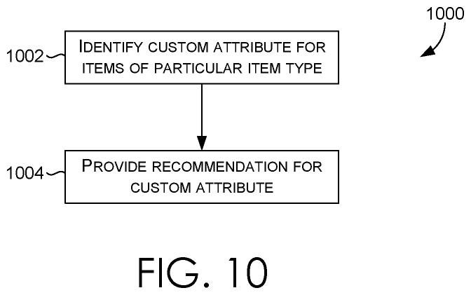

FIG. 10 provides a flow diagram showing a method 1000 for recommending a custom attribute. The method 1000 can be performed, for instance, by the search system 104 of FIG. 1. As shown at block 1002, a custom attribute is identified for items of a particular item type. In some instances, the custom attribute is identified when a custom attribute is generated for a single user (e.g., using the method 700 of FIG. 7). In other instances, the custom attribute is identified based on analysis of a collection of custom attributes from multiple users. This could be based on a frequency with which a particular custom attribute is generated by users. For instance, a machine learning model could be trained to identify commonly occurring custom attributes for a given item type. This could include clustering custom attributes based on features of the custom attributes and selecting a custom attribute based on a cluster including a threshold number of custom attributes.

The custom attribute is provided as a recommendation, as shown at block 1004. The custom attribute can be provided as a recommendation to different entities. In some aspects, the custom attribute recommendation is provided to a user of the search system. This allows the user to search items using the recommended custom attribute. Given the recommendation, the user can choose to sort and/or select/filter search results based on the recommended custom attribute. In some aspects, the custom attribute recommendation is provide to an administrator of the search system. This allows the administrator to determine whether to add the custom attribute as filter option provided in a user interface of the search system. In further aspects, the custom attribute recommendation is provided to a merchant offering an item of the particular item type for which the custom attribute was generated. This allows the merchant to determine whether to add information to the item listing for the item based on the custom attribute.

### Exemplary Operating Environment

Having described implementations of the present disclosure, an exemplary operating environment in which embodiments of the present technology may be implemented is described below in order to provide a general context for various aspects of the present disclosure. Referring initially to FIG. 11 in particular, an exemplary operating environment for implementing embodiments of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 11, computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 11 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1112 includes computer storage media in the form of volatile and/or nonvolatile memory. The memory may be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc. The I/O components 1120 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1100. The computing device 1100 may be equipped with depth cameras, such as, stereoscopic camera systems, infrared camera systems, RGB camera systems, and combinations of these for gesture detection and recognition. Additionally, the computing device 1100 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by a computing device, cause the computing device to perform operations, the operations comprising:
receiving user input associated with an image of a target item of an item type available on a listing platform;
responsive to the user input, analyzing the image of the target item to determine an attribute of the target item as a custom attribute;
for each of a plurality of other items of the item type available on the listing platform, analyzing an image of the other item to determine a value of the custom attribute for the other item; and
providing search results based at least in part on the values of the custom attribute for the other items.

2. The one or more computer storage media of claim 1, wherein receiving user input associated with the image of the target item comprises receiving a user selection of a portion of the target item in the image of the target item.

3. The one or more computer storage media of claim 2, wherein analyzing the image of the target item to determine the attribute of the target item comprises analyzing the portion of the target item.

4. The one or more computer storage media of claim 3, wherein the attribute of the target item comprises a dimension of the portion of the target item determined using one or more known dimensions of the target item.

5. The one or more computer storage media of claim 1, wherein providing the search results based at least in part on the values of the custom attribute for the other items comprises presenting an indication of the value of the custom attribute corresponding with each search result.

6. The one or more computer storage media of claim 5, wherein the custom attribute comprises a dimension of a portion of the other items, and wherein providing the search results based at least in part on the values of the custom attribute for the other items comprises presenting, within an image for each search result, a size reference image providing an indication of a relative size of a corresponding item for the search result.

7. The one or more computer storage media of claim 1, wherein providing the search results based at least in part on the values of the custom attribute for the other items comprises ordering the search results based at least in part on the values of the custom attribute for at least a portion of the other items.

8. The one or more computer storage media of claim 1, wherein providing the search results based at least in part on the values of the custom attributes for the other items comprises selecting the search results based at least in part on the values of the custom attribute for at least a portion of the other items.

9. The one or more computer storage media of claim 1, wherein the operations further comprise:
storing data regarding the values for the custom attributes for the other items in an item listing datastore.

10. The one or more computer storage media of claim 1, wherein the operations further comprise:
updating a user interface to add a filter option for the custom attribute.

11. The one or more computer storage media of claim 1, wherein the operations further comprise:
generating a recommendation for the custom attribute.

12. A computer-implemented method comprising:
receiving, via a user interface component, user input to generate a custom attribute associated with a target item;
analyzing, by a custom attribute component, an image of the target item to determine an attribute of the target item as the custom attribute;
determining, by the custom attribute component, a value for the custom attribute for each of a plurality of other items of the same item type as the target item;
storing, by an indexing component, data associating the values for the custom attributes with the other items in a search index; and
providing, by a search component, search results by querying the search index using the custom attribute as a search facet.

13. The computer-implemented method of claim 12, wherein the user input comprises a selection of a portion of the target item in the image of the target item, and wherein analyzing the image of the target item to determine the attribute of the target item comprises analyzing the portion of the target item.

14. The computer-implemented method of claim 12, wherein providing the search results comprises presenting an indication of the value of the custom attribute corresponding with each search result.

15. The computer-implemented method of claim 12, wherein providing the search results comprises ordering the search results based at least in part on the values of the custom attribute for at least a portion of the other items.

16. The computer-implemented method of claim 12, wherein providing the search results comprises selecting the search results based at least in part on the values of the custom attribute for at least a portion of the other items.

17. A computer system comprising:
a processor; and
a computer storage medium storing computer-useable instructions that, when used by the processor, causes the computer system to perform operations comprising:
receiving, via a user interface component, user input to generate a custom attribute;
analyzing, by a custom attribute component, an image for each of a plurality of items to determine a value for the custom attribute; and
providing, by a search component, search results using the values of the custom attribute as a search facet.

18. The computer system of claim 17, wherein providing the search results comprises presenting an indication of the value of the custom attribute corresponding with each search result.

19. The computer system of claim 17, wherein providing the search results comprises ordering the search results based at least in part on the values of the custom attribute for at least a portion of the items.

20. The computer system of claim 17, wherein providing the search results comprises selecting the search results based at least in part on the values of the custom attribute for at least a portion of the items.
